(19) United States
(12) Patent Application Publication
(10) Pub. No.: US 2024/0303497 A1
(43) Pub. Date: Sep. 12, 2024

(54) ROBUST TEST-TIME ADAPTATION WITHOUT ERROR ACCUMULATION

(71) Applicant: QUALCOMM Incorporated, San Diego, CA (US)

(72) Inventors: Jungsoo LEE, Paju (KR); Debasmit DAS, San Diego, CA (US); Sungha CHOI, Goyang-si (KR)

(21) Appl. No.: 18/360,712

(22) Filed: Jul. 27, 2023

Related U.S. Application Data
(60) Provisional application No. 63/488,922, filed on Mar. 7, 2023.

(51) Int. Cl. G06N 3/091; G06N 3/045

(52) U.S. Cl. CPC G06N 3/091; G06N 3/045

(57) ABSTRACT

A processor-implemented method for adapting an artificial neural network (ANN) at test-time includes receiving by a first ANN model and a second ANN model, a test data set. The test data set includes unlabeled data samples. The first ANN model is pretrained using a training data set and the test data set. The first ANN model generates first estimated labels for the test data set. The second ANN model generates second estimated labels for the test data set. Samples of the test data set are selected based on a confidence difference between the first estimated labels and the second estimated labels. The second ANN model is retrained based on the selected samples.

### CROSS-REFERENCE TO RELATED APPLICATION

The present application claims the benefit of U.S. Provisional Patent Application No. 63/488,922, filed on Mar. 7, 2023, and titled “ROBUST TEST-TIME ADAPTATION WITHOUT ERROR ACCUMULATION,” the disclosure of which is expressly incorporated by reference in its entirety.

### FIELD OF THE DISCLOSURE

Aspects of the present disclosure generally relate artificial neural networks, and more specifically to test-time adaptation without error accumulation.

### BACKGROUND

Artificial neural networks may comprise interconnected groups of artificial neurons (e.g., neuron models). The artificial neural network may be a computational device or be represented as a method to be performed by a computational device. Convolutional neural networks (CNNs) are a type of feed-forward artificial neural network. Convolutional neural networks may include collections of neurons that each have a receptive field and that collectively tile an input space. Convolutional neural networks, such as deep convolutional neural networks (DCNs), have numerous applications. In particular, these neural network architectures are used in various technologies, such as image recognition, speech recognition, acoustic scene classification, keyword spotting, autonomous driving, and other classification tasks.

Despite the recent advancements of deep learning, during long-term adaptation, deep neural network models may suffer degradation in model performance (e.g., accuracy) when trained with unlabeled data and when confronted with large domain shifts.

### SUMMARY

The present disclosure is set forth in the independent claims, respectively. Some aspects of the disclosure are described in the dependent claims.

In aspects of the present disclosure, a processor-implemented method includes receiving, by a first artificial neural network (ANN) model and a second ANN model, a test data set including unlabeled data samples. The first ANN model is pretrained using a training data set and the second ANN model is an adapted model. The method further includes generating, by the first ANN model, first estimated labels for the test data set. The method still further includes generating, by the second ANN model, second estimated labels for the test data set. The method also includes selecting samples of the test data set based on a confidence difference between the first estimated labels and the second estimated labels. The method further includes retraining the second ANN model based on the selected samples.

Other aspects of the present disclosure are directed to an apparatus. The apparatus includes means for receiving, by a first artificial neural network (ANN) model and a second ANN model, a test data set including unlabeled data samples. The first ANN model is pretrained using a training data set and the second ANN model is an adapted model. The apparatus further includes means for generating, by the first ANN model, first estimated labels for the test data set. The apparatus still further includes means for generating, by the second ANN model, second estimated labels for the test data set. The apparatus also includes means for selecting samples of the test data set based on a confidence difference between the first estimated labels and the second estimated labels. The apparatus further includes means for retraining the second ANN model based on the selected samples.

In other aspects of the present disclosure, a non-transitory computer-readable medium with non-transitory program code recorded thereon is disclosed. The program code is executed by a processor and includes program code to receive, by a first artificial neural network (ANN) model and a second ANN model, a test data set including unlabeled data samples. The first ANN model is pretrained using a training data set and the second ANN model is an adapted model. The program code further includes program code to generate, by the first ANN model, first estimated labels for the test data set. The program code still further includes program code to generate, by the second ANN model, second estimated labels for the test data set. The program code also includes program code to select samples of the test data set based on a confidence difference between the first estimated labels and the second estimated labels. The program code further includes program code to retrain the second ANN model based on the selected samples.

Other aspects of the present disclosure are directed to an apparatus. The apparatus having a memory and one or more processors coupled to the memory. The processor(s) is configured to receive, by a first artificial neural network (ANN) model and a second ANN model, a test data set including unlabeled data samples. The first ANN model is pretrained using a training data set and the second ANN model is an adapted model. The processor(s) is further configured to generate, by the first ANN model, first estimated labels for the test data set. The processor(s) is still further configured to generate, by the second ANN model, second estimated labels for the test data set. The processor(s) is also configured to select samples of the test data set based on a confidence difference between the first estimated labels and the second estimated labels. The processor(s) is further configured to retrain the second ANN model based on the selected samples.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of a neural network using a system-on-a-chip (SOC), including a general-purpose processor, in accordance with certain aspects of the present disclosure.

FIGS. 2A, 2B, and 2C are diagrams illustrating a neural network, in accordance with various aspects of the present disclosure.

FIG. 2D is a diagram illustrating an exemplary deep convolutional network (DCN), in accordance with various aspects of the present disclosure.

FIG. 3 is a block diagram illustrating an exemplary deep convolutional network (DCN), in accordance with various aspects of the present disclosure.

FIG. 4 is a block diagram illustrating an exemplary software architecture that may modularize artificial intelligence (AI) functions, in accordance with various aspects of the present disclosure.

FIG. 5 is a diagram illustrating an example framework for test-time adaptation of an artificial neural network (ANN), in accordance with various aspects of the present disclosure.

FIG. 6 is a block diagram illustrating an example process for adaptation of an artificial neural network (ANN) at test-time, in accordance with various aspects of the present disclosure.

FIG. 7 is a flow diagram illustrating a processor-implemented method for adaptation of an artificial neural network (ANN) at test-time, in accordance with various aspects of the present disclosure.

### DETAILED DESCRIPTION

The detailed description set forth below in connection with the appended drawings, is intended as a description of various configurations and is not intended to represent the only configurations in which the concepts described may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used to mean “serving as an example, instance, or illustration.” Any aspect described as “exemplary” is not necessarily to be construed as preferred or advantageous over other aspects.

Although particular aspects are described, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks, and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

As described, during long-term adaptation, artificial neural network (ANN) models may suffer degradation in model performance (e.g., accuracy) when trained with unlabeled data. Recently, test-time adaptation (TTA) has gained popularity as an approach to address the problems with long-term adaptation because TTA does not use the source data during the adaptation stage and the ground truth labels of the target domain. Instead, TTA models utilize a self-training strategy (e.g., entropy minimization), which uses estimated outputs as target outputs in loss functions. However, because TTA models rely on their own estimated labels to adapt to an unlabeled target distribution, TTA models may be prone to utilizing noisy signals. Noisy signals may indicate supervisions that originated from 1) incorrect labels, and 2) open-set estimates. An open set may refer to samples of unknown classes or classes that are not present in a source domain (e.g., a training data set). Performing model adaptation (e.g., training) with such noisy signals may degrade the TTA model performance (e.g., accuracy), especially during long-term adaptation.

Some conventional approaches use a pre-defined static threshold for selecting correct samples. However, these conventional approaches generally fail to provide precision (e.g., filter incorrect labels).

Another conventional approach involves entropy minimization. Entropy minimization attempts to raise the confidence of an individual sample's inference, but individual confidence values may rise or fall due to the influence of signals from numerous other inferences. The influence of the error signals due to other inferences may be referred to as the wisdom of crowds. In other words, a noisy signal misaligned with such ‘wisdom of crowds’ found in the correct signals may fail to raise individual confidence scores of incorrect inferences for samples, despite attempts to increase such confidence scores. While entropy minimization may compel the ANN model to increase the probability of its estimated label (e.g., may be referred to as a confidence value), noisy samples (e.g., incorrect label or open-set estimates) may decrease confidence values, thereby reducing the accuracy of the ANN model. Thus, long-term adaptation of ANN models is challenging.

Accordingly, to address these and other challenges, aspects of the present disclosure are directed to test-time adaptation of artificial neural networks. In accordance with aspects of the present disclosure, a neural network may be adapted at test time by filtering out samples with incorrect labels and selecting samples with a higher probability of having a correct label.

Particular aspects of the subject matter described in this disclosure can be implemented to realize one or more of the following potential advantages. In some examples, the described techniques, such as filtering out samples with incorrect labels and selecting samples with a higher probability of having a correct inference may beneficially reduce error accumulation and increase model accuracy during long-term adaption of the artificial neural network. Furthermore, aspects of the present disclosure may be applied to improve conventional approaches for long-term adaptation, such as TTA and entropy minimization, and may find broad application in fields such as object detection, autonomous vehicles, intelligent security, and federated learning, for instance.

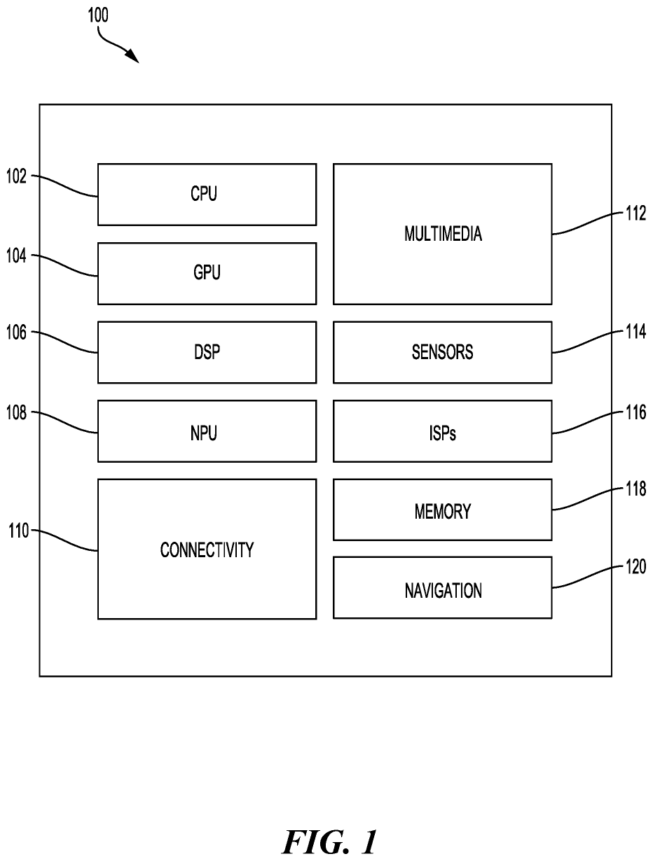

FIG. 1 illustrates an example implementation of a system-on-a-chip (SOC) 100, which may include a central processing unit (CPU) 102 or a multi-core CPU configured for test-time adaptation with reduced error accumulation. Variables (e.g., neural signals and synaptic weights), system parameters associated with a computational device (e.g., neural network with weights), delays, frequency bin information, and task information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long-term evolution (4G LTE) connectivity, WI-FI connectivity, USB connectivity, BLUETOOTH connectivity, and the like, and a multimedia processor 112 that may, for example, detect and recognize gestures. In one implementation, the NPU 108 is implemented in the CPU 102, DSP 106, and/or GPU 104. The SOC 100 may also include a sensor processor 114, image signal processors (ISPs) 116, and/or navigation module 120, which may include a global positioning system.

The SOC 100 may be based on an ARM instruction set. In an aspect of the present disclosure, the instructions loaded into the general-purpose processor 102 may include code to receive by a first artificial neural network (ANN) model and a second ANN model, a test data set including unlabeled data samples. The first ANN model is pretrained using a training data set and the second ANN model is an adapted model. The general-purpose processor 102 may also include code to generate by the first ANN model, first estimated labels for the test data set. The general-purpose processor 102 may additionally include code to generate by the second ANN model, second estimated labels for the test data set. The general-purpose processor 102 may further include code to select samples of the test data set based on a confidence difference between the first estimated labels and the second estimated labels. Furthermore, the general-purpose processor 102 may include code to retrain the second ANN model based on the selected samples.

Deep learning architectures may perform an object recognition task by learning to represent inputs at successively higher levels of abstraction in each layer, thereby building up a useful feature representation of the input data. In this way, deep learning addresses a major bottleneck of traditional machine learning. Prior to the advent of deep learning, a machine learning approach to an object recognition problem may have relied heavily on human engineered features, perhaps in combination with a shallow classifier. A shallow classifier may be a two-class linear classifier, for example, in which a weighted sum of the feature vector components may be compared with a threshold to predict to which class the input belongs. Human engineered features may be templates or kernels tailored to a specific problem domain by engineers with domain expertise. Deep learning architectures, in contrast, may learn to represent features that are similar to what a human engineer might design, but through training. Furthermore, a deep network may learn to represent and recognize new types of features that a human might not have considered.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

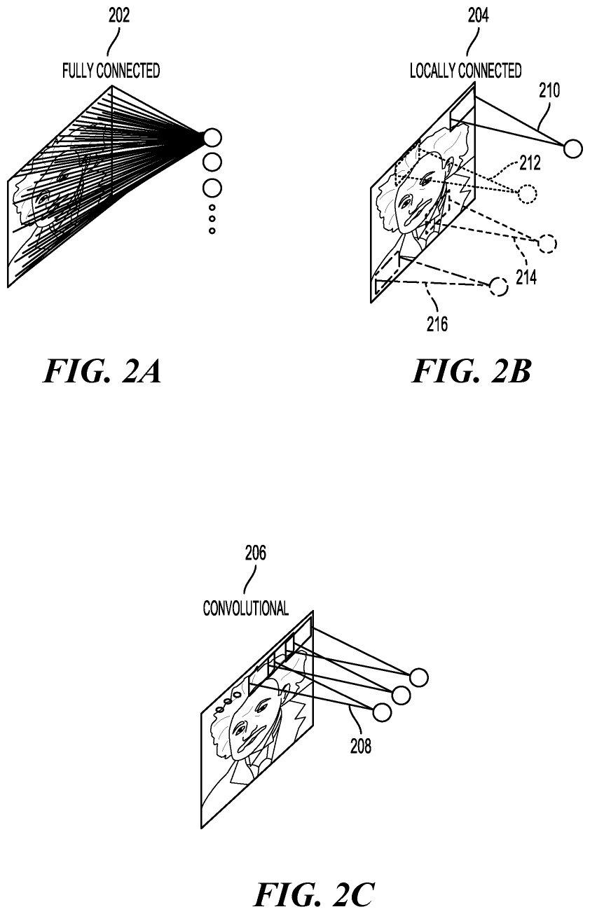

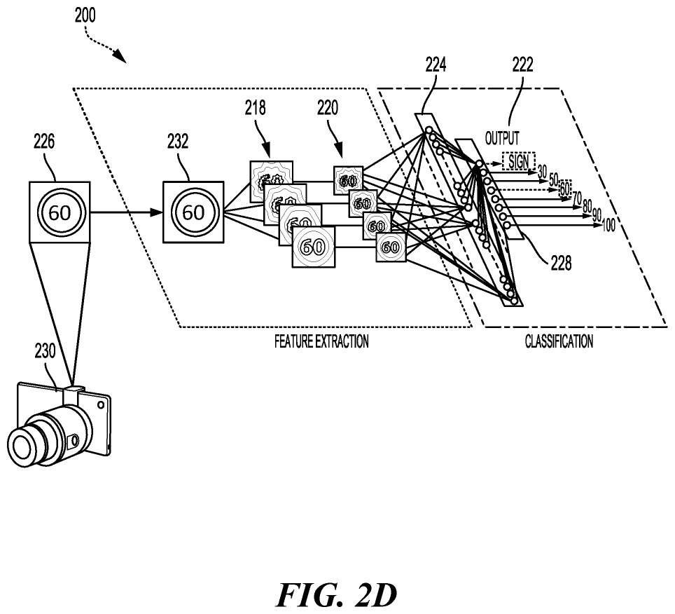

The connections between layers of a neural network may be fully connected or locally connected. FIG. 2A illustrates an example of a fully connected neural network 202. In a fully connected neural network 202, a neuron in a first layer may communicate its output to every neuron in a second layer, so that each neuron in the second layer will receive input from every neuron in the first layer. FIG. 2B illustrates an example of a locally connected neural network 204. In a locally connected neural network 204, a neuron in a first layer may be connected to a limited number of neurons in the second layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer because the higher layer neurons in a given region may receive inputs that are tuned through training to the properties of a restricted portion of the total input to the network.

One example of a locally connected neural network is a convolutional neural network. FIG. 2C illustrates an example of a convolutional neural network 206. The convolutional neural network 206 may be configured such that the connection strengths associated with the inputs for each neuron in the second layer are shared (e.g., 208). Convolutional neural networks may be well suited to problems in which the spatial location of inputs is meaningful.

One type of convolutional neural network is a deep convolutional network (DCN). FIG. 2D illustrates a detailed example of a DCN 200 designed to recognize visual features from an image 226 input from an image capturing device 230, such as a car-mounted camera. The DCN 200 of the current example may be trained to identify traffic signs and a number provided on the traffic sign. Of course, the DCN 200 may be trained for other tasks, such as identifying lane markings or identifying traffic lights.

The DCN 200 may be trained with supervised learning. During training, the DCN 200 may be presented with an image, such as the image 226 of a speed limit sign, and a forward pass may then be computed to produce an output 222. The DCN 200 may include a feature extraction section and a classification section. Upon receiving the image 226, a convolutional layer 232 may apply convolutional kernels (not shown) to the image 226 to generate a first set of feature maps 218. As an example, the convolutional kernel for the convolutional layer 232 may be a 5×5 kernel that generates 28×28 feature maps. In the present example, because four different feature maps are generated in the first set of feature maps 218, four different convolutional kernels were applied to the image 226 at the convolutional layer 232. The convolutional kernels may also be referred to as filters or convolutional filters.

The first set of feature maps 218 may be subsampled by a max pooling layer (not shown) to generate a second set of feature maps 220. The max pooling layer reduces the size of the first set of feature maps 218. That is, a size of the second set of feature maps 220, such as 14×14, is less than the size of the first set of feature maps 218, such as 28×28. The reduced size provides similar information to a subsequent layer while reducing memory consumption. The second set of feature maps 220 may be further convolved via one or more subsequent convolutional layers (not shown) to generate one or more subsequent sets of feature maps (not shown).

In the example of FIG. 2D, the second set of feature maps 220 is convolved to generate a first feature vector 224. Furthermore, the first feature vector 224 is further convolved to generate a second feature vector 228. Each feature of the second feature vector 228 may include a number that corresponds to a possible feature of the image 226, such as “sign,” “60,” and “100.” A softmax function (not shown) may convert the numbers in the second feature vector 228 to a probability. As such, an output 222 of the DCN 200 may be a probability of the image 226 including one or more features.

In the present example, the probabilities in the output 222 for “sign” and “60” are higher than the probabilities of the others of the output 222, such as “30,” “40,” “50,” “70,” “80,” “90,” and “100”. Before training, the output 222 produced by the DCN 200 may likely be incorrect. Thus, an error may be calculated between the output 222 and a target output. The target output is the ground truth of the image 226 (e.g., “sign” and “60”). The weights of the DCN 200 may then be adjusted so the output 222 of the DCN 200 is more closely aligned with the target output.

To adjust the weights, a learning algorithm may compute a gradient vector for the weights. The gradient may indicate an amount that an error would increase or decrease if the weight were adjusted. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted to reduce the error. This manner of adjusting the weights may be referred to as “back propagation” as it involves a “backward pass” through the neural network.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level. After learning, the DCN 200 may be presented with new images and a forward pass through the DCN 200 may yield an output 222 that may be considered an inference or a prediction of the DCN 200.

Deep belief networks (DBNs) are probabilistic models comprising multiple layers of hidden nodes. DBNs may be used to extract a hierarchical representation of training data sets. A DBN may be obtained by stacking up layers of Restricted Boltzmann Machines (RBMs). An RBM is a type of artificial neural network that can learn a probability distribution over a set of inputs. Because RBMs can learn a probability distribution in the absence of information about the class to which each input should be categorized, RBMs are often used in unsupervised learning. Using a hybrid unsupervised and supervised paradigm, the bottom RBMs of a DBN may be trained in an unsupervised manner and may serve as feature extractors, and the top RBM may be trained in a supervised manner (on a joint distribution of inputs from the previous layer and target classes) and may serve as a classifier.

DCNs are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer, with each element of the feature map (e.g., 220) receiving input from a range of neurons in the previous layer (e.g., feature maps 218) and from each of the multiple channels. The values in the feature map may be further processed with a non-linearity, such as a rectification, max(0, x). Values from adjacent neurons may be further pooled, which corresponds to down sampling, and may provide additional local invariance and dimensionality reduction. Normalization, which corresponds to whitening, may also be applied through lateral inhibition between neurons in the feature map.

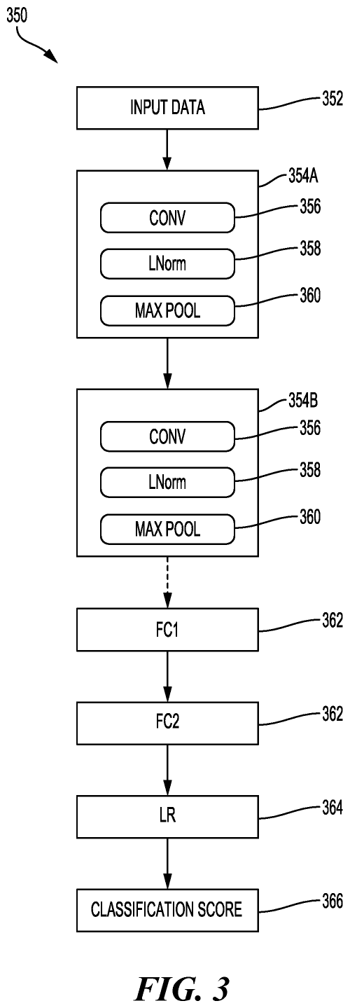

FIG. 3 is a block diagram illustrating a DCN 350. The DCN 350 may include multiple different types of layers based on connectivity and weight sharing. As shown in FIG. 3, the DCN 350 includes the convolution blocks 354A, 354B. Each of the convolution blocks 354A, 354B may be configured with a convolution layer (CONV) 356, a normalization layer (LNorm) 358, and a max pooling layer (MAX POOL) 360.

Although only two of the convolution blocks 354A, 354B are shown, the present disclosure is not so limiting, and instead, any number of the convolution blocks 354A, 354B may be included in the DCN 350 according to design preference.

The convolution layers 356 may include one or more convolutional filters, which may be applied to the input data to generate a feature map. The normalization layer 358 may normalize the output of the convolution filters. For example, the normalization layer 358 may provide whitening or lateral inhibition. The max pooling layer 360 may provide down sampling aggregation over space for local invariance and dimensionality reduction.

The parallel filter banks, for example, of a deep convolutional network may be loaded on a CPU 102 or GPU 104 of an SOC 100 (e.g., FIG. 1) to achieve high performance and low power consumption. In alternative embodiments, the parallel filter banks may be loaded on the DSP 106 or an ISP 116 of an SOC 100. In addition, the DCN 350 may access other processing blocks that may be present on the SOC 100, such as sensor processor 114 and navigation module 120, dedicated, respectively, to sensors and navigation.

The DCN 350 may also include one or more fully connected layers 362 (FC1 and FC2). The DCN 350 may further include a logistic regression (LR) layer 364. Between each layer 356, 358, 360, 362, 364 of the DCN 350 are weights (not shown) that are to be updated. The output of each of the layers (e.g., 356, 358, 360, 362, 364) may serve as an input of a succeeding one of the layers (e.g., 356, 358, 360, 362, 364) in the DCN 350 to learn hierarchical feature representations from input data 352 (e.g., images, audio, video, sensor data and/or other input data) supplied at the first of the convolution blocks 354A. The output of the DCN 350 may be a classification score 366 for the input data 352. The classification score 366 may be a set of probabilities, where each probability is the probability of the input data including a feature from a set of features.

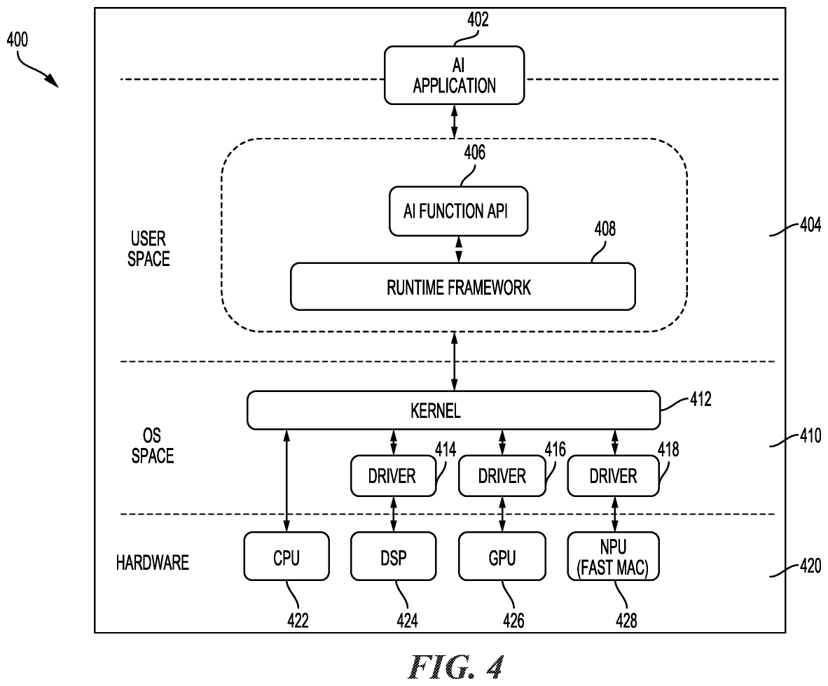

FIG. 4 is a block diagram illustrating an exemplary software architecture 400 that may modularize artificial intelligence (AI) functions. Using the architecture 400, applications may be designed that may cause various processing blocks of an SOC 420 (for example a CPU 422, a DSP 424, a GPU 426 and/or an NPU 428) (which may be similar to SOC 100 of FIG. 1) to support test-time adaptation with reduced error accumulation for an AI application 402, according to aspects of the present disclosure. The architecture 400 may, for example, be included in a computational device, such as a smartphone.

The AI application 402 may be configured to call functions defined in a user space 404 that may, for example, provide for the detection and recognition of a scene indicative of the location at which the computational device including the architecture 400 currently operates. The AI application 402 may, for example, configure a microphone and a camera differently depending on whether the recognized scene is an office, a lecture hall, a restaurant, or an outdoor setting such as a lake. The AI application 402 may make a request to compiled program code associated with a library defined in an AI function application programming interface (API) 406. This request may ultimately rely on the output of a deep neural network configured to provide an inference response based on video and positioning data, for example.

A run-time engine 408, which may be compiled code of a runtime framework, may be further accessible to the AI application 402. The AI application 402 may cause the run-time engine 408, for example, to request an inference at a particular time interval or triggered by an event detected by the user interface of the AI application 402. When caused to provide an inference response, the run-time engine 408 may in turn send a signal to an operating system in an operating system (OS) space 410, such as a Kernel 412, running on the SOC 420. In some examples, the Kernel 412 may be a LINUX Kernel. The operating system, in turn, may cause a continuous relaxation of quantization to be performed on the CPU 422, the DSP 424, the GPU 426, the NPU 428, or some combination thereof. The CPU 422 may be accessed directly by the operating system, and other processing blocks may be accessed through a driver, such as a driver 414, 416, or 418 for, respectively, the DSP 424, the GPU 426, or the NPU 428. In the exemplary example, the deep neural network may be configured to run on a combination of processing blocks, such as the CPU 422, the DSP 424, and the GPU 426, or may be run on the NPU 428.

As described, aspects of the present disclosure are directed to test-time adaptation of artificial neural networks (ANN). In accordance with various aspects of the present disclosure, test samples for an ANN model may be filtered based on a confidence metric corresponding to a probability of estimating a correct label. For example, test samples with confidence values that are lower in an adapted model than in the original model may be filtered out as likely noise signals in training the ANN model. The ANN model may then be trained using only the remaining samples (e.g., samples with confidence values that are greater in the adapted model than in the original model) after filtering.

Accordingly, various aspects of the present disclosure may be broadly applicable to conventional methods such as test time adaptation (TTA), for example, and may improve performance (e.g., error reduction) of such conventional approaches on image classification and semantic segmentation, for instance.

Moreover, aspects of the present disclosure may reduce, and in some aspects avoid, erroneous signals from unsupervised loss functions, such as entropy minimization. As such, aspects of the present disclosure may facilitate a long-term stable adaptation by minimizing error accumulation from unsupervised loss.

During adaptation of ANN models at test-time, ANN models may adapt to a target domain D_{T} with N number of test samples {xᵢ,}ᵢ₌₁^{N}∈D_{T} without target labels provided. A pretrained model θₒ (may also be referred to as “original model θₒ”) may be updated to adapt to a new target domain. The adapted model may be defined as θₐ. A softmax output of a test sample x may be defined using the original model θₒ as \tilde{y}=f(x; θₒ)∈ [symbol] ^{C}, with C number of target classes, respectively. The estimated class of the test sample x using the original model θₒ may be expressed as cₒ=argmax_{c}f(x; θₒ). The probability of the estimated label for the test sample x using the original model θₒ may then be defined as \tilde{y}^{c}^{ₒ}. Similarly, for the adapted model θₐ, the estimated class of the test sample x using the adapted model θₐ may be given by cₐ=argmax_{c}f(x; θₐ) and the probability of the estimated label for the test sample x using the adapted model θₐ may be defined as ŷ^{c}^{ₐ}. As such, one objective of test-time adaptation may be to correctly estimate the class cₐ of the test sample x using the adapted model θₐ, especially with large data distribution shifts.

The importance of correctly estimating the class of the test sample x in the open set may be illustrated, for example, in the context of real-world applications such as autonomous vehicles, where the initial training set includes roads and certain types of vehicles (e.g., sedan or sport utility vehicle) but may not include labels for sidewalks and guardrails. Using incorrect labels to adapt the ANN model of the autonomous vehicle may, for example, result in incorrectly estimating that a sidewalk or a guardrail may be a road, and may lead to a collision.

In accordance with some aspects of the present disclosure, sample selection for test-time adaptation may be conducted using a confidence difference between \tilde{y}^{c}^{ₒ} and ŷ^{c}^{ₐ}. That is, the probability (\tilde{y}^{c}^{ₒ}) that the estimated label for the test sample x using the original model θₒ and the probability (ŷ^{c}^{ₐ}) that the estimated label for the test sample x using the adapted model θₐ may each be considered confidence values. Accordingly, a sample selection criterion may be formulated as follows:

$$Φ ( x ; {θ}_{a} , {θ}_{o} ) = {{\hat{y}}^{{c}_{a}} \geq {\tilde{y}}^{{c}_{o}}}_{} ( x ) , \qquad ( 1 )$$

where Φ(x) is the sample selection criterion and [symbol] is the indicator function. The indicator function maps elements of a subset of a set to one and all other elements of the set to zero.

In some aspects, a pseudo label may be determined for unlabeled data for which the confidence value of the adapted model θₐ is greater than or equal to the confidence value of the original model θₒ (e.g., ŷ^{c}^{ₐ}≥\tilde{y}^{c}^{ₒ}).

By using the selection criterion of Equation 1, a total objective function for entropy minimization may be formulated as:

$${ℒ}^{main} ( x ; {θ}_{a} ) = Φ ( x ) \cdot H ( {\tilde{y}}_{i} ) - {max}_{} H ( \overline{y} ) , \qquad ( 2 )$$

where the entropy H(p)=Σₖ₌₁^{C}p^{k} log p^{k}, p represents the predicted probability value of each class,

$$\overline{y} = \frac{1}{N} {\sum }_{k = 1}^{C} {\tilde{y}}_{i} ,$$

and [symbol] ₘₐₓ is the scalar value for balancing the two loss values. H(y̅) may prevent the ANN model from making imbalanced estimates towards a certain class.

Aspects of the present disclosure may employ the wisdom of crowds to effectively select test samples for adapting ANN models at test time. That is, given a certain estimated label, the loss signals from correct samples may reach a consensus that may be helpful for increasing the confidence value on the estimated class. On the other hand, the loss signals from the noisy samples (e.g., incorrectly estimated labels) may misalign with such correct labels learned from the correct samples. In other words, although the supervision from each individual sample may encourage the ANN model to increase the confidence level for each sample, the increases may be nullified by the wisdom of crowds learned from the majority of the correct samples. By using such an observation, samples that achieve a higher confidence value using the adapted model θₐ compared to those using the original model θₒ may be selected. Because a knowledge state of the ANN model may be reflected on each individual sample, the selection may be considered a dynamic thresholding strategy, which may beneficially outperform the previously used static strategies.

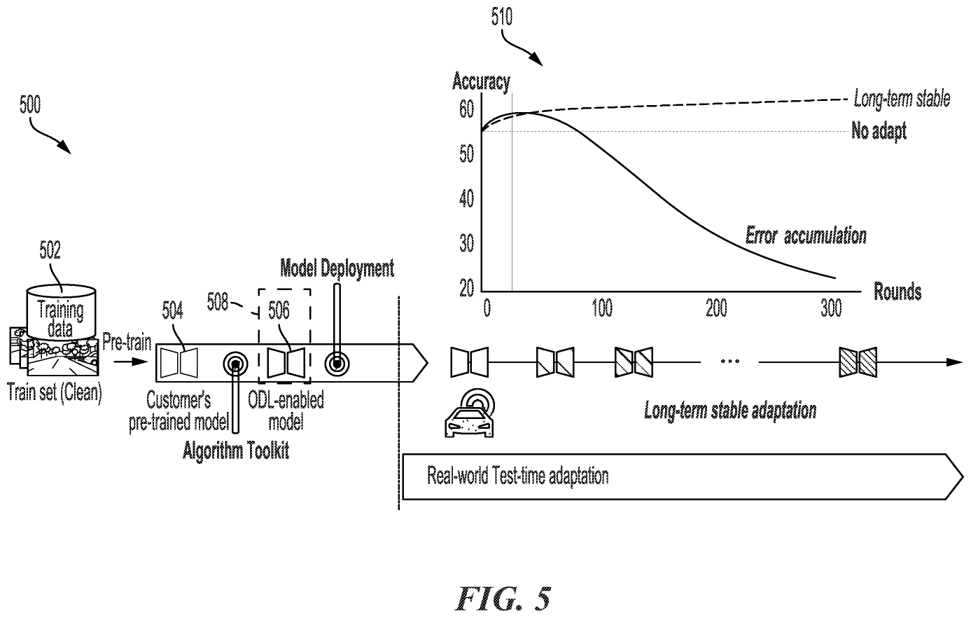

FIG. 5 is a diagram illustrating example a framework 500 for test-time adaptation of an artificial neural network, in accordance with aspects of the present disclosure. Referring to FIG. 5, the example framework 500 includes an artificial neural network (ANN) model 504 that may be trained using a training data set 502. The training data set 502 may include a set of labeled data samples. The data samples may, for example, comprise visual data (e.g., images or video), audio data, sensor data or other types of data. The ANN model 504 (referred to as “pre-trained ANN model 504”) may be communicated to a user device 508 to generate a local model 506. The user device 508 may be (but is not limited to) a mobile device such as smartphone, an autonomous vehicle, wearable technology device (e.g., smartwatch or smartglasses), an Internet of things (IoT) device, or other mobile computing device, for instance. The local model 506 may retrain on-device using data samples developed at the user device 508. As the local model 506 may be deployed at the user device 508, the local model 506 may observe unlabeled data samples. Unlabeled data samples may refer to data samples for which there may be no target label in the training data set 502.

Adaptation of the local model 506 without target labels may over time result in a noisy loss signal in an unsupervised learning setting (e.g., without data sample annotation). The noisy loss signal may, for instance, be due to an incorrect estimated label. Over time, accumulation of such errors may erode the accuracy of the local model 506. To reduce such errors, aspects of the present disclosure may select samples for retraining the local model 506 based on a confidence metric. That is, retraining may be performed using only samples with a higher probability of estimating a correct label. As shown in a graph 510, by retraining the local model 506, as the number of adaptations (shown as rounds) increases, the error accumulation may be reduced while the accuracy of the retrained local model 506 may remain stable (e.g., substantially the same).

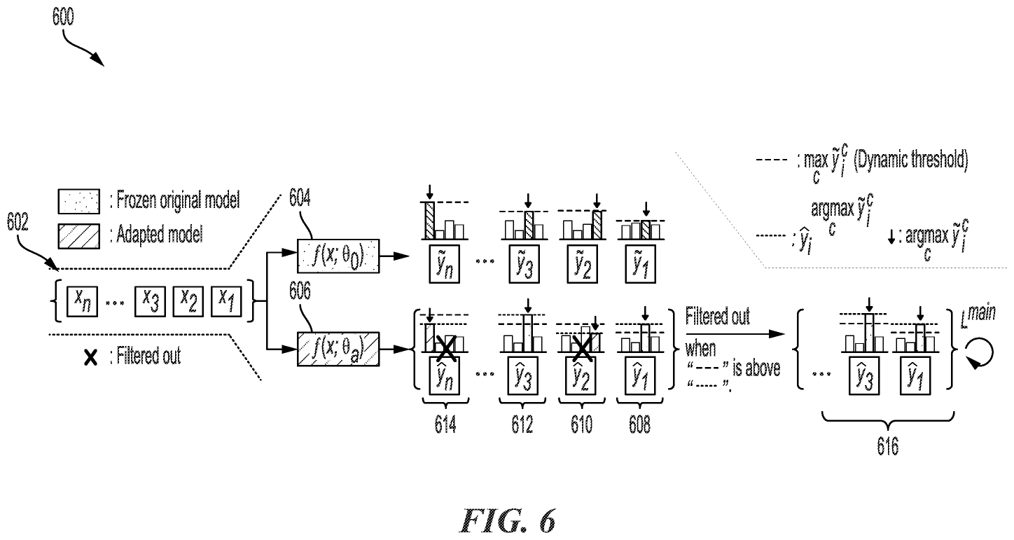

FIG. 6 is a block diagram illustrating an example process 600 for adaptation of an ANN at test time, in accordance with aspects of the present disclosure. Referring to FIG. 6, an original model θₒ 604 and an adapted model θₐ 606 may each receive a set 602 (e.g., minibatch) of N number of test samples (e.g., images), {xᵢ}ᵢ₌₁^{N}. The original model θₒ 604 and the adapted model θₐ 606 may each process the set 602 of test samples xᵢ to determine an estimate of a label (e.g., a classification) for the test samples. For each test sample xᵢ of the set 602, the probability \tilde{y}^{c}^{ₒ} of the estimated label using the original model θₒ 604 may be compared to the probability ŷcₐ of the estimated label using the adapted model θₐ 606.

The probability values ŷ^{c}^{ₒ} and \tilde{y}^{c}^{ₒ} may serve as confidence values that indicate a likelihood of a correctly estimated label, as described. The example process 600 selects the samples of the adapted model θₐ 606 for which the confidence value is greater than or equal to the confidence value of the original model θₒ 604 (ŷ^{c}^{ₐ}≥\tilde{\tilde{y}}^{c}^{ₒ}) (e.g., 608, 612). For instance, at 608, for test input x₁, the confidence value for the adapted model θₐ 606 is greater than the confidence value for the original model θₒ 604 (e.g . . . ŷ₁≥\tilde{y}₁). In this case, the sample of the adapted model θₐ 606 may be selected for retraining the adapted model θₐ 606. In some aspects, if the test input x₁ is unlabeled data (e.g., there may be no ground truth label), the estimated label generated by the adapted model θₐ 606 may serve as a pseudo label and may be stored in a memory unit, for instance.

On the other hand, if the confidence value for the original model θₒ 604 is greater than the confidence value for the adapted model θₐ 606, the samples of the adapted model θₐ 606 may be filtered out (e.g., 610, 614). For example, as shown in FIG. 6, at 610, for test input x₂, the confidence value for the adapted model θₐ 606 is less than the confidence value for the original model θₒ 604 (e.g., ŷ₂<\tilde{y}₂). In this example, the sample of the adapted model θₐ 606 may be filtered out and may not be used for retraining the adapted model θₐ 606. In some aspects, unselected samples (e.g., the estimated label generated by the adapted model θₐ 606) of the adapted model θₐ 606 may be discarded.

Accordingly, by selecting samples based on the confidence difference (e.g., ŷ^{c}^{ₐ}≥\tilde{y}₂), the threshold for selecting samples may be changed in accordance with the level of confidence of the original model θₒ 604. Thus, a dynamic threshold may be implemented for retraining the adapted model θₐ 606 using only the selected samples (e.g., 616) based on the varying threshold.

Thereafter, the process 600 may apply the entropy minimization of Equation 2 using only the selected samples (e.g., ŷ₁, ŷ₃ as shown at 616) of the adapted model θₐ 606.

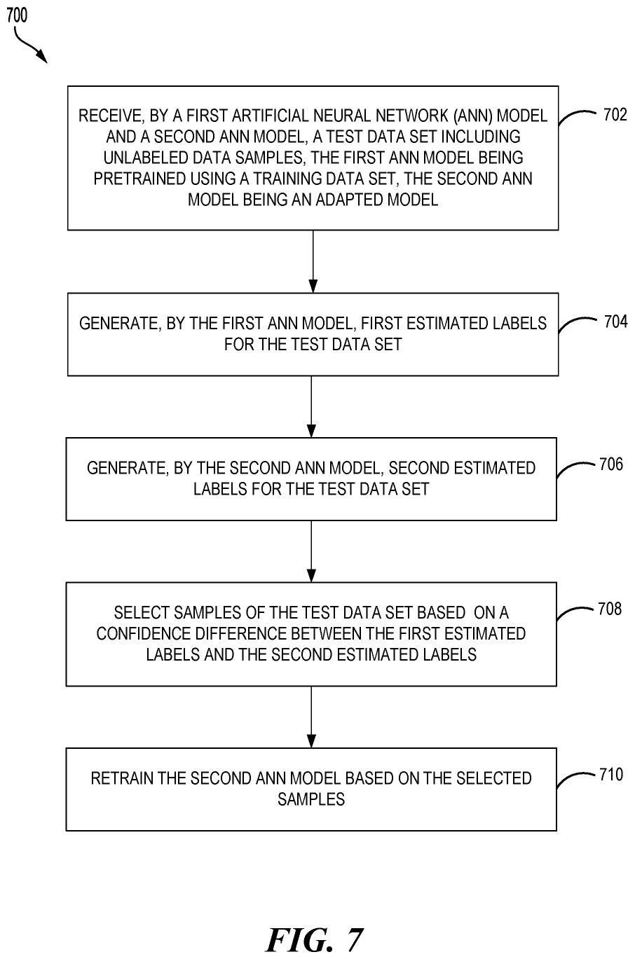

FIG. 7 is a flow diagram illustrating a processor-implemented method 700 for adaptation of an artificial neural network at test-time, in accordance with aspects of the present disclosure. The processor-implemented method 700 may be performed by one or more processors such as the CPU (e.g., 102, 422), GPU (e.g., 104, 426), and/or other processing units (e.g., DSP 106, 424 and/or NPU 108, 428), for example.

As shown in FIG. 7, at block 702, the processor receives, by a first artificial neural network (ANN) model and a second ANN model, a test data set including unlabeled data samples. The first ANN model is pretrained using a training data set. The second ANN model is an adapted model (e.g., adapted from the first ANN model). For instance, as described with reference to FIG. 6, an original model θₒ 604 and an adapted model θₐ 606 may each receive a set 602 (e.g., mini batch) of N number of test samples (e.g., images), {xᵢ}ᵢ₌₁^{N}.

At block 704, the processor generates, by the first ANN model, first estimated labels for the test data set. At block 706, the processor generates, by the second ANN model, second estimated labels for the test data set. For example, as described with reference to FIG. 6, The original model θₒ 604 and the adapted model θₐ 606 may each process the set 602 of test samples to determine an estimate of a label (e.g., a classification) for the test samples.

At block 708, the processor selects samples of the test data set based on a confidence difference between the first estimated labels and the second estimated labels. As described with reference to FIG. 6, for each test sample xᵢ of the set 602, the probability \tilde{y}^{c}^{ₒ} of the estimated label using the original model θₒ 604 may be compared to the probability ŷ^{c}^{ₐ} of the estimated label using the adapted model θₐ 606. As described, the probability values ŷ^{c}^{ₒ} and \tilde{y}^{c}^{ₒ} may serve as confidence values that indicate a likelihood of a correctly estimated label. The example process 600 selects the samples of the adapted model θₐ 606 for which the confidence value is greater than or equal to the confidence value of the original model θₒ 604 (ŷ^{c}^{ₐ}≥ \tilde{y}^{c}^{ₒ}).

At block 710, the processor retrains the second ANN model based on the selected samples. As described with reference to FIG. 6, the process 600 may apply the entropy minimization of Equation 2 using only the selected samples (e.g., ŷ₁, ŷ₃) of the adapted model θₐ 606.

Implementation examples are provided in the following numbered clauses:

1. A processor-implemented method comprising:
receiving, by a first artificial neural network (ANN) model and a second ANN model, a test data set including unlabeled data samples, the first ANN model being pretrained using a training data set, the second ANN model being an adapted model;
generating, by the first ANN model, first estimated labels for the test data set;
generating, by the second ANN model, second estimated labels for the test data set;
selecting samples of the test data set based on a confidence difference between the first estimated labels and the second estimated labels; and
retraining the second ANN model based on the selected samples.

2. The processor-implemented method of clause 1, further comprising:
receiving, by the retrained second ANN model, an input;
processing, by the retrained second ANN model, the input to generate a feature representation of the input; and
generating, by the retrained second ANN model, an inference relative to the input based on the feature representation.

3. The processor-implemented method of clause 1 or 2, further comprising:
determining first confidence values for the first estimated labels and second confidence values for the second estimated labels; and
selecting samples of the test data set for which the second confidence values are greater than the first confidence values.

4. The processor-implemented method of any of clauses 1-3, further comprising discarding unselected samples of the test data set.

5. The processor-implemented method of any of clauses 1-4, in which the second estimated label is used as a pseudo label if corresponding test data comprises an unlabeled data sample.

6. The processor-implemented method of any of clauses 1-5, further comprising retraining the second ANN model using entropy minimization.

7. The processor-implemented method of any of clauses 1-6, in which the second ANN is retrained using only the selected samples.

8. An apparatus, comprising:
at least one memory; and
at least one processor coupled to the at least one memory, the at least one processor configured to:
   receive, by a first artificial neural network (ANN) model and a second ANN model, a test data set including unlabeled data samples, the first ANN model being pretrained using a training data set, the second ANN model being an adapted model;
   generate, by the first ANN model, first estimated labels for the test data set;
   generate, by the second ANN model, second estimated labels for the test data set;
   select samples of the test data set based on a confidence difference between the first estimated labels and the second estimated labels; and
   retrain the second ANN model based on the selected samples.

9. The apparatus of clause 8, in which the at least one processor is further configured to:
receive, by the retrained second ANN model, an input;
process, by the retrained second ANN model, the input to generate a feature representation of the input; and
generate, by the retrained second ANN model, an inference relative to the input based on the feature representation.

10. The apparatus of clause 8 or 9, in which the at least one processor is further configured to:
determine first confidence values for the first estimated labels and second confidence values for the second estimated labels; and
select samples of the test data set for which the second confidence values are greater than the first confidence values.

11. The apparatus of any of clauses 8-10, in which the at least one processor is further configured to discard unselected samples of the test data set.

12. The apparatus of any of clauses 8-11, in which the second estimated label is used as a pseudo label if corresponding test data comprises an unlabeled data sample.

13. The apparatus of any of clauses 8-12, in which the at least one processor is further configured to retrain the second ANN model using entropy minimization.

14. The apparatus of any of clauses 8-13, in which the at least one processor is further configured to retrain the second ANN using only the selected samples.

15. A non-transitory computer-readable medium having program code recorded thereon, the program code executed by a processor and comprising:
program code to receive, by a first artificial neural network (ANN) model and a second ANN model, a test data set including unlabeled data samples, the first ANN model being pretrained using a training data set, the second ANN model being an adapted model;
program code to generate, by the first ANN model, first estimated labels for the test data set;
program code to generate, by the second ANN model, second estimated labels for the test data set;
program code to select samples of the test data set based on a confidence difference between the first estimated labels and the second estimated labels; and
program code to retrain the second ANN model based on the selected samples.

16. The non-transitory computer-readable medium of clause 15, in which the program code further comprises:
program code to receive, by the retrained second ANN model, an input;
program code to process, by the retrained second ANN model, the input to generate a feature representation of the input; and
program code to generate, by the retrained second ANN model, an inference relative to the input based on the feature representation.

17. The non-transitory computer-readable medium of clause 15 or 16, in which the program code further comprises:
program code to determine first confidence values for the first estimated labels and second confidence values for the second estimated labels; and
program code to select samples of the test data set for which the second confidence values are greater than the first confidence values.

18. The non-transitory computer-readable medium of any of clauses 15-17, in which the program code further comprises program code to discard unselected samples of the test data set.

19. The non-transitory computer-readable medium of any of clauses 15-18, in which the second estimated label is used as a pseudo label if corresponding test data comprises an unlabeled data sample.

20. The non-transitory computer-readable medium of any of clauses 15-19, in which the program code further comprises program code to retrain the second ANN model using entropy minimization.

21. The non-transitory computer-readable medium of any of clauses 15-20, in which the program code further comprises program code to retrain the second ANN using only the selected samples.

22. An apparatus, comprising:
means for receiving, by a first artificial neural network (ANN) model and a second ANN model, a test data set including unlabeled data samples, the first ANN model being pretrained using a training data set, the second ANN model being an adapted model;
means for generating, by the first ANN model, first estimated labels for the test data set;
means for generating, by the second ANN model, second estimated labels for the test data set;
means for selecting samples of the test data set based on a confidence difference between the first estimated labels and the second estimated labels; and
means for retraining the second ANN model based on the selected samples.

23. The apparatus of clause 22, further comprising:
means for receiving, by the retrained second ANN model, an input;
means for processing, by the retrained second ANN model, the input to generate a feature representation of the input; and
means for generating, by the retrained second ANN model, an inference relative to the input based on the feature representation.

24. The apparatus of clause 22 or 23, further comprising:
means for determining first confidence values for the first estimated labels and second confidence values for the second estimated labels; and
means for selecting samples of the test data set for which the second confidence values are greater than the first confidence values.

25. The apparatus of any of clauses 22-24, further comprising means for discarding unselected samples of the test data set.

26. The apparatus of any of clauses 22-25, in which the second estimated label is used as a pseudo label if corresponding test data comprises an unlabeled data sample.

27. The apparatus of any of clauses 22-26, further comprising means for retraining the second ANN model using entropy minimization.

28. The apparatus of any of clauses 22-27, further comprising means for retraining the second ANN using only the selected samples.

In one aspect, the receiving means, generating means, selecting means and/or retraining means may be the CPU 102, program memory associated with the CPU 102, NPU 108, the dedicated memory block 118, fully connected layers 362, NPU 428 and/or the routing connection processing unit 216 configured to perform the functions recited. In another configuration, the aforementioned means may be any module or any apparatus configured to perform the functions recited by the aforementioned means.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used, the term “determining” encompasses a wide variety of actions. For example, “determining” may include calculating, computing, processing, deriving, investigating, looking up (e.g., looking up in a table, a database, or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described and may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used, include compact disc (CD), laser disc, optical disc, digital versatile disc (DVD), floppy disk, and Blu-ray® disc where disks usually reproduce data magnetically, while discs reproduce data optically with lasers. Thus, in some aspects, computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented. For example, such a computer program product may comprise a computer-readable medium having instructions stored (and/or encoded) thereon, the instructions being executable by one or more processors to perform the operations described. For certain aspects, the computer program product may include packaging material.

Further, it should be appreciated that modules and/or other appropriate means for performing the methods and techniques described can be downloaded and/or otherwise obtained by a user terminal and/or base station as applicable. For example, such a device can be coupled to a server to facilitate the transfer of means for performing the methods described. Alternatively, various methods described can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A processor-implemented method comprising:
receiving, by a first artificial neural network (ANN) model and a second ANN model, a test data set including unlabeled data samples, the first ANN model being pretrained using a training data set, the second ANN model being an adapted model;
generating, by the first ANN model, first estimated labels for the test data set;
generating, by the second ANN model, second estimated labels for the test data set;
selecting samples of the test data set based on a confidence difference between the first estimated labels and the second estimated labels; and
retraining the second ANN model based on the selected samples.

2. The processor-implemented method of claim 1, further comprising:
receiving, by the retrained second ANN model, an input;
processing, by the retrained second ANN model, the input to generate a feature representation of the input; and
generating, by the retrained second ANN model, an inference relative to the input based on the feature representation.

3. The processor-implemented method of claim 1, further comprising:
determining first confidence values for the first estimated labels and second confidence values for the second estimated labels; and
selecting samples of the test data set for which the second confidence values are greater than the first confidence values.

4. The processor-implemented method of claim 3, further comprising discarding unselected samples of the test data set.

5. The processor-implemented method of claim 3, in which the second estimated label is used as a pseudo label if corresponding test data comprises an unlabeled data sample.

6. The processor-implemented method of claim 1, further comprising retraining the second ANN model using entropy minimization.

7. The processor-implemented method of claim 1, in which the second ANN is retrained using only the selected samples.

8. An apparatus, comprising:
at least one memory; and
at least one processor coupled to the at least one memory, the at least one processor configured to:
receive, by a first artificial neural network (ANN) model and a second ANN model, a test data set including unlabeled data samples, the first ANN model being pretrained using a training data set, the second ANN model being an adapted model;
generate, by the first ANN model, first estimated labels for the test data set;
generate, by the second ANN model, second estimated labels for the test data set;
select samples of the test data set based on a confidence difference between the first estimated labels and the second estimated labels; and
retrain the second ANN model based on the selected samples.

9. The apparatus of claim 8, in which the at least one processor is further configured to:
receive, by the retrained second ANN model, an input;
process, by the retrained second ANN model, the input to generate a feature representation of the input; and
generate, by the retrained second ANN model, an inference relative to the input based on the feature representation.

10. The apparatus of claim 8, in which the at least one processor is further configured to:
determine first confidence values for the first estimated labels and second confidence values for the second estimated labels; and
select samples of the test data set for which the second confidence values are greater than the first confidence values.

11. The apparatus of claim 10, in which the at least one processor is further configured to discard unselected samples of the test data set.

12. The apparatus of claim 10, in which the second estimated label is used as a pseudo label if corresponding test data comprises an unlabeled data sample.

13. The apparatus of claim 8, in which the at least one processor is further configured to retrain the second ANN model using entropy minimization.

14. The apparatus of claim 8, in which the at least one processor is further configured to retrain the second ANN using only the selected samples.

15. A non-transitory computer-readable medium having program code recorded thereon, the program code executed by a processor and comprising:
program code to receive, by a first artificial neural network (ANN) model and a second ANN model, a test data set including unlabeled data samples, the first ANN model being pretrained using a training data set, the second ANN model being an adapted model;
program code to generate, by the first ANN model, first estimated labels for the test data set;
program code to generate, by the second ANN model, second estimated labels for the test data set;
program code to select samples of the test data set based on a confidence difference between the first estimated labels and the second estimated labels; and
program code to retrain the second ANN model based on the selected samples.

16. The non-transitory computer-readable medium of claim 15, in which the program code further comprises:
program code to receive, by the retrained second ANN model, an input;
program code to process, by the retrained second ANN model, the input to generate a feature representation of the input; and
program code to generate, by the retrained second ANN model, an inference relative to the input based on the feature representation.

17. The non-transitory computer-readable medium of claim 15, in which the program code further comprises:
program code to determine first confidence values for the first estimated labels and second confidence values for the second estimated labels; and
program code to select samples of the test data set for which the second confidence values are greater than the first confidence values.

18. The non-transitory computer-readable medium of claim 17, in which the program code further comprises program code to discard unselected samples of the test data set.

19. The non-transitory computer-readable medium of claim 17, in which the second estimated label is used as a pseudo label if corresponding test data comprises an unlabeled data sample.

20. The non-transitory computer-readable medium of claim 15, in which the program code further comprises program code to retrain the second ANN model using entropy minimization.

21. The non-transitory computer-readable medium of claim 15, in which the program code further comprises program code to retrain the second ANN using only the selected samples.

22. An apparatus, comprising:
means for receiving, by a first artificial neural network (ANN) model and a second ANN model, a test data set including unlabeled data samples, the first ANN model being pretrained using a training data set, the second ANN model being an adapted model;
means for generating, by the first ANN model, first estimated labels for the test data set;
means for generating, by the second ANN model, second estimated labels for the test data set;
means for selecting samples of the test data set based on a confidence difference between the first estimated labels and the second estimated labels; and
means for retraining the second ANN model based on the selected samples.

23. The apparatus of claim 22, further comprising:
means for receiving, by the retrained second ANN model, an input;
means for processing, by the retrained second ANN model, the input to generate a feature representation of the input; and
means for generating, by the retrained second ANN model, an inference relative to the input based on the feature representation.

24. The apparatus of claim 22, further comprising:
means for determining first confidence values for the first estimated labels and second confidence values for the second estimated labels; and
means for selecting samples of the test data set for which the second confidence values are greater than the first confidence values.

25. The apparatus of claim 24, further comprising means for discarding unselected samples of the test data set.

26. The apparatus of claim 24, in which the second estimated label is used as a pseudo label if corresponding test data comprises an unlabeled data sample.

27. The apparatus of claim 22, further comprising means for retraining the second ANN model using entropy minimization.

28. The apparatus of claim 22, further comprising means for retraining the second ANN using only the selected samples.
